(19) United States
(12) Patent Application Publication
(10) Pub. No.: US 2023/0098402 A1
(43) Pub. Date: Mar. 30, 2023

(54) PROVIDING MULTI-DEVICE SERVICE USING NETWORK APPLICATION PROGRAMMING INTERFACE

(71) Applicant: Nokia Solutions and Networks Oy, Espoo (FI)

(72) Inventor: Shiwen LIU, Qingdao (CN)

(21) Appl. No.: 17/795,798

(22) PCT Filed: Feb. 3, 2020
(86) PCT No.: PCT/CN2020/074249

§ 371 Date: Jul. 27, 2022

(51) Int. Cl. H04L 65/1073; H04L 65/1093

(52) U.S. Cl. CPC H04L 65/1073; H04L 65/1093

(57) ABSTRACT

Providing multi-device services using a network application programming interface. The server obtains the accessibility in-ormation which indicates the plurality of devices and their capabilities. The plurality of devices have a same user identity. In this way, the server can take control on devices of participate for MuD services.

### FIELD

Embodiments of the present disclosure generally relate to communication techniques, and more particularly, to methods, devices and computer readable medium for providing multi-device services using a network application programming interface.

### BACKGROUND

With the development of communication technologies, Multi-Device (MuD) service has been proposed which enables a user to use different User Equipment (UE) that are registered under the same Public User Identity (PUID). The UEs can be of different types (for example, phone, tablet, wearable device) and can support a communication log. An outgoing call can be made from any of the federated UEs. An incoming call towards the served user is sent to all federated UEs. The call can be accepted on any of the federated UEs which are alerting the served user of an incoming call. There is a single “primary device” that is typically a mobile smartphone but can also be a fixed device. The MuD service is useful to empower a user to use different devices in convenience manner with same PUID.

### SUMMARY

Generally, embodiments of the present disclosure relate to a method for providing multi-device services using a network application programming interface and corresponding devices.

In a first aspect, there is provided a method. The method comprises receiving, at a first device and from a second device, accessibility information associated with a user identity, the accessibility information indicating a plurality of devices using the user identity and capabilities of the plurality of devices. The method also comprises in accordance with a detection of a change in a communication session associated with the plurality of devices, selecting at least one target device from the plurality of devices based on the capabilities of the plurality of devices and a requirement of the communication session. The method further comprises transmitting identity information of the at least one target device to the second device.

In a second aspect, there is provided a method. The method comprises transmitting, at a second device and to a first device, accessibility information associated with a user identity, the accessibility information indicating a plurality of devices using the user identity and capabilities of the plurality of devices. The method also comprises in an accordance with a determination of a change in a communication session associated with the plurality of devices, receiving identity information of at least one target device from the first device, the at least one target device being determined based on the capabilities of the plurality of devices and a requirement of the communication session. The method further comprises transmitting a request associated with the change to the at least one target device.

In a third aspect, there is provided a method. The method comprises transmitting, at a third device and to a second device, a register request indicating identity information of the third device and a capability of the third device, the third device using a user identity, accessibility information associated with the user identity comprising the identity information of the third device and the capability of the third device. The method also comprises in accordance with a determination of a change in a communication session associated with the plurality of devices, receiving a request associated with the change from the second device. The method further comprises generating a response to the request. The method yet comprises transmitting the response to the second device.

In a fourth aspect, there is provided a first device. The first device comprises at least one processor; and at least one memory including computer program codes; the at least one memory and the computer program codes are configured to, with the at least one processor, cause the first device to receive accessibility information associated with a user identity from a second device, the accessibility information indicating a plurality of devices using the user identity and capabilities of the plurality of devices. The first device is also caused to in an accordance with a detection of a change in a communication session associated with the plurality of devices, select at least one target device from the plurality of devices based on the capabilities of the plurality of devices and a requirement of the communication session. The first device is further caused to transmit identity information of the at least one target device to the second device.

In a fifth aspect, there is provided a second device. The second device comprises at least one processor; and at least one memory including computer program codes; the at least one memory and the computer program codes are configured to, with the at least one processor, cause the second device to transmit, at a second device and to a first device, accessibility information associated with a user identity, the accessibility information indicating a plurality of devices using the user identity and capabilities of the plurality of devices. The second device is also caused to in an accordance with a determination of a change in a communication session associated with the plurality of devices, receive identity information of at least one target device from the first device, the at least one target device being determined based on the capabilities of the plurality of devices and a requirement of the communication session. The second device is further caused to transmit a request associated with the change to the at least one target device.

In a sixth aspect, there is provided a third device. The third device comprises at least one processor; and at least one memory including computer program codes; the at least one memory and the computer program codes are configured to, with the at least one processor, cause the third device to transmit to a second device a register request indicating identity information of the third device and a capability of the third device, the third device using a user identity, accessibility information associated with the user identity comprising the identity information of the third device and the capability of the third device. The third device is also caused to in accordance with a determination of a change in a communication session associated with the plurality of devices, receive a request associated with the change from the second device. The third device is further caused to generate a response to the request. The third device is yet caused to transmit the response to the second device.

In a seventh aspect, there is provided an apparatus. The apparatus comprises means for receiving, at a first device, accessibility information associated with a user identity from a second device, the accessibility information indicating a plurality of devices using the user identity and capabilities of the plurality of devices; means for in an accordance with a determination of a change in a communication session associated with the plurality of devices, selecting at least one target device from the plurality of devices based on the capabilities of the plurality of devices and a requirement of the communication session; and means for transmitting identity information of the at least one target device to the second device.

In an eighth aspect, there is provided an apparatus. The apparatus comprises means for transmitting, at a second device and to a first device, accessibility information associated with a user identity, the accessibility information indicating a plurality of devices using the user identity and capabilities of the plurality of devices; means for in an accordance with a determination of a change in a communication session associated with the plurality of devices, receiving identity information of at least one target device from the first device, the at least one target device being determined based on the capabilities of the plurality of devices and a requirement of the communication session; and means for transmitting a request associated with the change to the at least one target device.

In a ninth aspect, there is provided an apparatus. The apparatus comprises means for transmitting, at a third device and to a second device, a register request indicating identity information of the third device and a capability of the third device, the third device using a user identity, accessibility information associated with the user identity comprising the identity information of the third device and the capability of the third device; means for in an accordance with a determination of a change in a communication session associated with the plurality of devices, receiving a request associated with the change from the second device; means for generating a response to the request; and means for determining a set of fallback resources for transmitting the response to the second device.

In a tenth aspect, there is provided a computer readable medium comprising program instructions for causing an apparatus to perform at least the method according to the above fifth, sixth, seventh, or eighth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates a schematic diagram of a communication system according to embodiments of the present disclosure;

FIG. 2 illustrates a flow chart of a method according to embodiments of the present disclosure;

FIG. 3 illustrates a flow chart of a method according to embodiments of the present disclosure;

FIG. 4 illustrates a flow chart of a method according to embodiments of the present disclosure;

FIG. 5 illustrates a signaling chart of interactions between devices according to embodiments of the present disclosure;

FIG. 6 illustrates a signaling chart of interactions between devices according to embodiments of the present disclosure;

FIG. 7 illustrates a signaling chart of interactions between devices according to embodiments of the present disclosure;

FIG. 8 illustrates a signaling chart of interactions between devices according to embodiments of the present disclosure;

FIG. 9 illustrates a signaling chart of interactions between devices according to embodiments of the present disclosure;

FIG. 10 illustrates a simplified block diagram of an apparatus that is suitable for implementing embodiments of the present disclosure; and

FIG. 11 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:

(a) hardware-only circuit implementations (such as implementations in only analog and/or digital circuitry) and

(b) combinations of hardware circuits and software, such as (as applicable):

(i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and

(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), New Radio (NR) and so on. Furthermore, the communications between a terminal device and a network device in the communication network may be performed according to any suitable generation communication protocols, including, but not limited to, the first generation (1G), the second generation (2G), 2.5G, 2.65 G, the third generation (3G), the fourth generation (4G), 4.5 G the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, the user has to use the terminal device to perform the control of MuD. For user and operator, it's hard to manage MuD in dynamic manner. It's impossible to let web application to take control on MuD service as well. It shall be flexible and powerful if both user and web application can take a control on MuD service base on demand, which is the direction of convergence between telecom and OTT. There is strong demand to connect with more and more intelligent device as well.

Currently, the IP Multimedia Subsystem (IMS) and Telephony Application Server (TAS) support MuD service. The IMS knows the registered device information and is able to connect with target device. The high-level capabilities:

(1) Registration/Deregistration

When device using MuD register in IMS network, the device shall include following parameters and tags in the Contact header to inform the network of its capabilities:

+sip.instance: unique value of device that distinguishes this device from the other devices that share the same PUID;
video: to indicate that the device can support video call;
urn:urn-7:3 gpp-service.ims.icsi.mmtel: to indicate that the device supports IMS applications;
+g.gsma.rcs.ipcall: to indicate that the device supports Rich Communication Services (RCS);
mobility=“fixed” or “mobile”: to indicate that the device is fixed or mobile.

(2) Call Processing

It proposes the Globally Routable User agent URI (GRUU) mechanism, which allows devices that share a common PUID to be individually contacted. As part of normal REGISTER processing, the S-CSCF generates a public GRUU (pub-grcc) and a temporary GRUU (temp-gruu), derived from the received+sip.instance parameter. Within the third-party REGISTER sent to the TAS, the S-CSCF encapsulates the 200 OK REGISTER response that was sent to the UE, and the TAS extracts the public GRUU information from the Contact header within the encapsulated 200 OK.

It proposes the SIP Accept-Contact and Reject-Contact headers, which allows a UAC (User Agent Client) to supply caller preferences that can be used to drive terminating call processing and device selection. Within the third-party REGISTER sent from the S-CSCF to the TAS, the encapsulated 200 OK REGISTER response that was sent to the UE contains the feature tags and parameters supplied by the UE, and the TAS can preserve this information for each registered device.

When the terminal device makes an outgoing call, it can include related parameters and tags in the Contact header to indicate device id and its capabilities. The IMS network can perform the connection with target devices based on its identifier and capabilities.

The OMA defines the RESTful Network application programming interface (API) to manage the capability of network. The following capabilities are enabled on via RESTful Network API:

(1) The Terminal Status API sends notification on accessibility change and queries terminal status on participant level (PUID). The Application Server (AS) can use this API to get participant status.

(2) The Call Notification API includes participants information on the communication session. The AS can know participants information and take control on target participant to connect with base on Call Notification API.

(3)The Third Party Call API manages the call participants in the communication session. The AS can use this API to specific participants in the communication session and add/delete/transfer participant in active communication session.

(4) The Audio Call API plays media to specific participant. The AS can use this API to play media to specific participant.

However, there are no defined APIs to allow notification and control on device level, which is mandatory to MuD service. Without API, the web applications are not able to take part in and control on MuD service. With API, it's possible and easy to connect more and more intelligent device into communication session.

According to embodiments of the present disclosure, the server obtains the accessibility information which indicates the plurality of devices and their capabilities. The plurality of devices has a same user identity. In this way, the server can take control on devices of participate for MuD services.

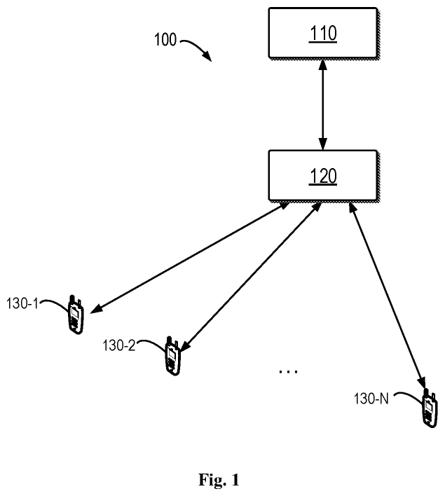

FIG. 1 illustrates a schematic diagram of a communication system 100 in which embodiments of the present disclosure can be implemented. The communication system 100, which is a part of a communication network, comprises a first device 110. The communication system 100 further comprises a second device 120. The communication 100 also comprises third devices 130-1, 130-2, . . . , 130-N, where N is an integer number (collectively referred to as “third device(s) 130”). It is to be understood that the numbers of different devices shown in FIG. 1 are given for the purpose of illustration without suggesting any limitations.

The first device 110 may comprise a server. The second device 120 may be a core network device, for example, a telephony application server. The third device 130 may be terminal devices. The first device 110 and the third device 130 can also be interchangeable.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

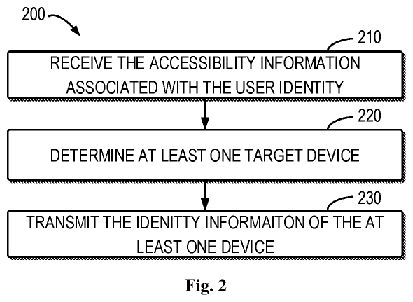

FIG. 2 illustrates a flow chart of method 200 according to embodiments of the present disclosure. The method 200 can be implemented at any suitable devices. For example, the method may be implemented at the first device 110.

At block 210, the first device 110 receives accessibility information associated with a user identity. For example, the user identity may be a public user identity (PUID). The accessibility information indicates a plurality of devices, for example, the devices 130, using the user identity. The devices 130 may use the same PUID. The accessibility information also indicates capabilities of the plurality of devices 130. For example, the capability may be audio capability. Alternatively, the capability may be video capability. In this way, the first device 110 can specify the suitable device under the same user identity.

In some embodiments, the first device 110 may create subscription to the accessibility information. For example, the first device 110 may transmit a request indicating the user identity to the second device 120. In other embodiments, if the accessibility information is updated, the first device 110 may receive the updated accessibility information.

At block 220, the first device 110 selects at least one target device (for example, the third device 130-1) from the plurality of devices 130 based on the capabilities of the plurality of devices and a requirement of the communication session. In an example embodiment, the first device 110 may determine to initiate a communication session. The first device 110 may select one or more target devices from the plurality of devices 130. The capabilities of the one or more target devices may satisfy the requirement of the communication session. For example, if the communication session needs video capability, the first device 110 may select the target device which supports video. In some embodiments, the communication session may refer to a call session. It should be noted that that the communication session can be any suitable communication sessions.

In some embodiments, the first device 110 may determine to add one or more devices into the communication session. The first device 110 may select one or more target devices from the plurality of devices 130. The capabilities of the one or more target devices may satisfy the requirement of the communication session. For example, if the communication session needs audio capability, the first device 110 may select the target device which supports audio.

In some embodiments, the first device 110 may determine to replace a participant device in the communication session. In an example embodiment, the first device 110 may determine the at least one target device from the plurality of devices 130 to replace the participant device. The at least one target device and the participant device may have the same user identity. In other embodiments, the at least one target device and the participant device may have different user identities.

At block 230, the first device 110 transmits the identity information of the at least one target device to the second device 120. In some embodiments, the first device 110 may receive an acknowledgment from the second device 120.

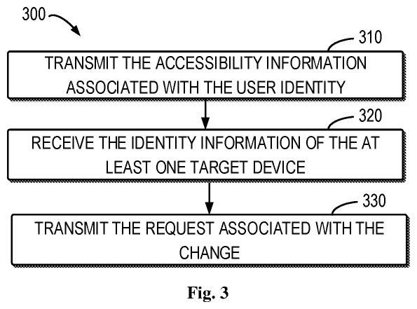

FIG. 3 illustrates a flow chart of method 300 according to embodiments of the present disclosure. The method 300 can be implemented at any suitable devices. For example, the method may be implemented at the second device 120.

At block 310, the second device 120 transmits accessibility information associated with the user identity. For example, the user identity may be a PUID. The accessibility information indicates a plurality of devices, for example, the devices 130, using the user identity. The devices 130 may use the same PUID. The accessibility information also indicates capabilities of the plurality of devices 130. For example, the capability may be audio capability. Alternatively, the capability may be video capability. In this way, the first device 110 can specify the suitable device under the same user identity.

In some embodiments, the first device 110 may create subscription to the accessibility information. For example, the second device 120 may receive a request indicating the user identity from the first device 110. In other embodiments, if the accessibility information is updated, the second device 120 may transmit the updated accessibility information.

At block 320, the second device 120 receives the identity information of the at least one target device to the second device 120. In some embodiments, the second device 120 may transmit an acknowledgment to the first device 110.

At block 330, the second device 120 transmits a request associated with the change to the at least one target device, for example, the third device 130-1. In an example embodiment, if the communication session is initiated, the second device 120 may transmit the request to the third device 130-1 to participate the communication session.

In some embodiments, if a device is added into the communication session, the second device 120 may transmit the request to the third device 130-1 to participate the communication session. In other embodiments, if a participant device is replaced with one target device, the second device 120 may transmit the request to the target device to participate the communication session and transmit a further request to the participant device to leave the communication session. The at least one target device and the participant device may have the same user identity. In other embodiments, the at least one target device and the participant device may have different user identities.

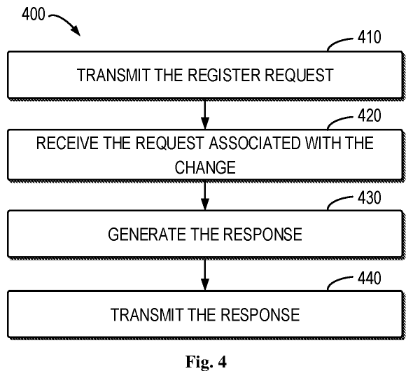

FIG. 4 illustrates a flow chart of method 400 according to embodiments of the present disclosure. The method 400 can be implemented at any suitable devices. For example, the method may be implemented at the third device 130-1.

At block 410, the third device 130-1 transmits a register request. The register request indicates identity information of the third device 130-1. The register request also indicates the capability of the third device 130-1. For example, the register request may indicate that the third device 130-1 supports video and/or audio.

At block 420, the third device 130-1 receives a request associated with a change in a communication session. In an example embodiment, if the communication session is initiated, the third device 130-1 may receive the request from the second device 120 to participate the communication session.

In some embodiments, if the third device 130-1 is determined to add into the communication session, the third device 130-1 may receive the request from the second device 120 to participate the communication session. In other embodiments, if a participant device is determined to be replaced with the third device 130-1, the third device 130-1 may receive the request from the second device 120 to participate the communication session. Alternatively, if the third device 130-1 is determined to be replaced with a further device, the third device 130-1 may receive the request from the second device to leave the communication session.

At block 430, the third device 130-1 generates the response to the request. For example, if the third device 130-1 determines to accept the request, the third device 130-1 may generate an acknowledgement (ACK). For example, if the third device 130-1 determines to reject the request, the third device 130-1 may generate a non-acknowledgement (NACK). At block 440, the third device 130-1 transmits the response to the second device 120.

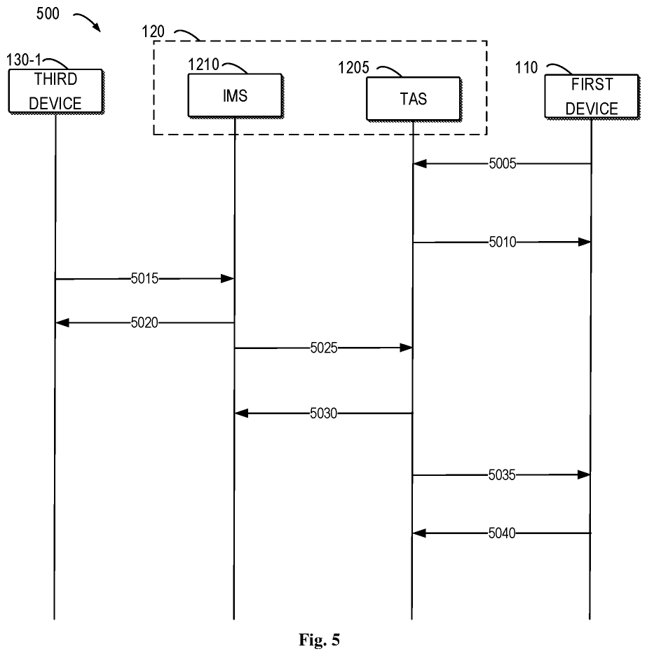

FIGS. 5-9 illustrate signaling charts of interactions among devices according to some embodiments of the present disclosure. It should be noted that the interactions shown in FIGS. 5-9 are only examples not limitations. As shown in FIGS. 5-9, the second device 120 may comprises a TAS 1205 and an IP multimedia subsystem 1210.

FIG. 5 illustrates a signaling chart of interactions 500 among devices according to embodiments of the present disclosure. The interactions 500 can be implemented among any suitable devices. Only for the purpose of illustrations, the interactions 500 are described with the reference to the first device 110, the second device 120 and the third device 130-1. It should be noted that the third device 130-1 is only an example not a limitation.

The first device 110 transmits 5005 a request indicating the user identity to create subscription to the accessibility information associated with the user identity. The TAS 1205 transmits 5010 the accessibility information to the first device 110. For example, the first device 110 may receive the accessibility information with terminal status API.

The first device 110 can subscribe the accessibility status on register or de-register of terminal devices. Once the terminal device registers or de-registers in network, the first device 110 can get the accessibility status notification. To allow the first device 110 getting the device information, the device information is added into the accessibility information.

For example, there may be some changes on the terminal status API. In some embodiments, multiDevice element in AccessibilityChangeNotification type and new MultiDevice type may be added. Then the first device 110 can get the accessibility information when receives accessibility change notification. Tables 1-5 show changes on the terminal status API.

TABLE 1
Type: AccessibilityChangeNotification

| Element | Type | Optional | Description |
|---|---|---|---|
| multiDevice | MultiDevice | Yes | Collection of |
| | [0 . . . unbounded] | | devices |

TABLE 2
Type: MultiDevice

| Element | Type | Optional | Description |
|---|---|---|---|
| instance | xsd: string | No | Unique value of |
| | | | device that |
| | | | distinguishes this |
| | | | device from the |
| | | | other devices that |
| | | | share the same |
| | | | subscriber address |
| | | | (Public User |
| | | | Identity). |
| deviceType | DeviceType | Yes | Type of device |
| | | | (fixed or mobile) |
| mediaType | Media | Yes | Media type device |
| | | | supports (audio, |
| | | | video). |
| capability | Capability | Yes | The capability |
| | | | device supports |

TABLE 3
Enumeration: DeviceType

| Enumeration | Description |
|---|---|
| Fixed | Fixed device |
| Mobile | Mobile device |

TABLE 4
Enumeration: Capability

| Enumeration | Description |
|---|---|
| IMS | The device supports IMS applications |
| RCS | The device supports Rich |
| | Communication Services (RCS) |

To allow the first device 110 to retrieve current registered devices, the currentMultiDevice element is added in TerminalAccessibilityStatus.

TABLE 4
TerminalAccessibilityStatus

| Element | Type | Optional | Description |
|---|---|---|---|
| currentMultiDevice | MultiDevice | Yes | Collection of |
| | [0 . . . unbounded] | | devices |

The third device 130-1 transmits 5015 a register request to the IMS 1210. The register request indicates identity information of the third device 130-1. The register request also indicates the capability of the third device 130-1. The IMS 1210 transmits 5020 the acknowledgment to the third device 130-1. The IMS 1210 transmits 5025 contact header comprising device capabilities and the user identity to the TAS 1205. The TAS 1205 transmits 5030 the acknowledgment to the IMS 1210. The TAS 1205 transmits 5035 the updated accessibility information to the first device 110. The first device 110 transmits 5040 the acknowledgment to the TAS 1205.

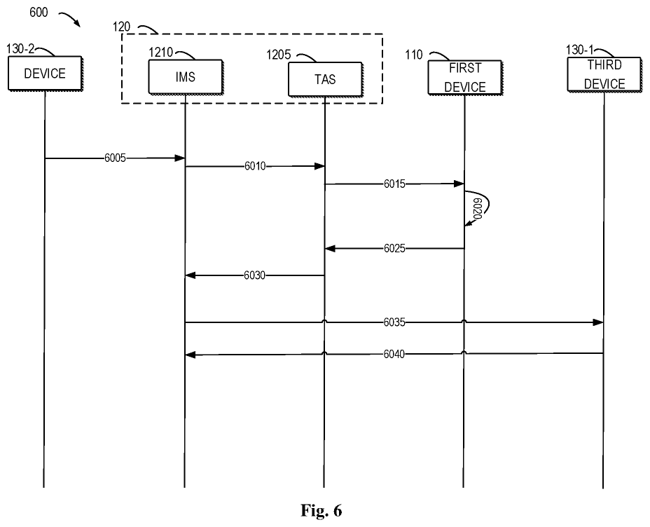

FIG. 6 illustrates a signaling chart of interactions 600 among devices according to embodiments of the present disclosure. The interactions 600 can be implemented among any suitable devices. For the purpose of illustrations, the interactions 600 are described with the reference to the first device 110, the second device 120, the third device 130-1 and the device 130-2. It should be noted that the third device 130-1 is only an example not a limitation.

The device 130-2 transmits 6005 a request to the IMS 1210 to initiate the communication session. The IMS 1210 transmits 6010 the request to the TAS 1205. The IMS 1210 transmits 6015 the request to the first device 110.

In some embodiments, the accessibility information may comprise associated devices of participant information. For example, the callingMultiDevice and calledMultiDevice elements are added in CallEventNotification to indicate associated devices of calling and called participants. Table 5 contains the details of the call event notified by the application for purposes of Call Direction or Call Notification handling.

TABLE 5
Type: CallEventNotification

| Element | Type | Optional | Description |
|---|---|---|---|
| callingMultiDevice | MultiDevice | Yes | The device of the |
| | | | caller |
| calledMultiDevice | MultiDevice | Yes | The device of the |
| | [0 . . . unbounded] | | called. (The called |
| | | | device can be |
| | | | multiple before call |
| | | | answers). |

The first device 110 selects 6020 the third device 130-1 based on the accessibility information. For example, if the third device 130-1 and device 130-3 (not shown) have the same user identity and the third device 130-1 supports video but the device 130-3 does not support video, the first device 110 may select the third device 130-1 when the communication session needs video support. For example, in the response of Call Notification API with CallDirection type, the first device 110 can specify one or more target devices to connect with for Continue and Route action. The connectingDevice element is added to specific the target device(s). Table 6 specifies the action to perform in response to a Call Direction notification.

TABLE 6

| Element name | Element type | Optional | Description |
|---|---|---|---|
| connectingDevice | xsd: string | Yes | The device(s) to be |
| | [0 . . . unbounded] | | used in case the |
| | | | action indicates |
| | | | ‘Continue’ or |
| | | | ‘Route’. |

The first device 110 transmits 6025 the identity information of the third device 130-1 to the TAS 1205. The TAS 1205 transmits 6030 the identity information of the third device 130-1 to the IMS 1210. The 1210 IMS transmits 6035 the request to the third device 130-1 and the third device 130-1 transmits 6040 to the IMS 1210.

In some embodiments, the third Party Call API is to manage participant devices in the communication session. To support device, the “/devices” related resources are added under participants. The following resource is to specific a device of participant in a communication session: http://{serverRoot}/thirdpartycall/{apiVersion}/call Sessions/{call SessionId}/partici pants/{participantId}/devices/{deviceId}

In order to remove a participant device from the communication session, if it is not intended to access the resource representing this participant's device in the communication session after the device's removal, the first device 110 may delete the resource: http://{serverRoot}/thirdpartycall/{apiVersion}/call Sessions/{call SessionId}/participants/{participantId}/devices/{deviceId}. In other embodiments, if it is intended to access information about this participant's device in the communication session after the device's removal, the first devic3e 110 may use the POST method to submit a termination request to the resource http://{serverRoot}/thirdpartycall/{apiVersion}/call Sessions/{call SessionId}/participants/{participantId}/devices/{deviceId}/terminate.

In order to make a call transfer on device, the first device 110 may use the POST method to submit the resourceURL identifying the target session to the resource below: http://{serverRoot}/thirdpartycall/{apiVersion}/call Sessions/{call Sessionld}/participants/{participantId}/transfer/devices/{deviceId}/transfer.

In some embodiments, a new participantDevice element may be added in CallParticipantlnformation type to specific the device.

TABLE 7
Call Participant Information

| Element | Element type | optional | Description |
|---|---|---|---|
| participantDevice | ParticipantDevice- | Yes | The device(s) |
| | Information | | of the |
| | [0 . . . unbounded] | | participant. |

TABLE 8
Participant Device Information

| Element | Element type | Optional | Description |
|---|---|---|---|
| device | xsd: string | No | The device of the |
| | | | participant. |
| resourceURL | xsd: anyURI | Yes | Sel freferring |
| | | | URL. The |
| | | | resourceURL |
| | | | SHALL NOT be |
| | | | included in POST |
| | | | requests by the |
| | | | client, but MUST |
| | | | be included in |
| | | | POST requests |
| | | | representing |
| | | | notifications by |
| | | | the server to the |
| | | | client, when a |
| | | | complete |
| | | | representation of |
| | | | the resource is |
| | | | embedded in the |
| | | | notification. The |
| | | | resourceURL |
| | | | MUST also be |
| | | | included in |
| | | | responses to any |
| | | | HTTP method that |
| | | | returns an entity |
| | | | body, and in PUT |
| | | | requests. |

TABLE 9
Transfer Parameters

| Element | Type | Optional | Description |
|---|---|---|---|
| destinationDevice | xsd: string | Yes | The device of |
| | [0 . . . unbounded] | | participant to |
| | | | which the device |
| | | | is to be |
| | | | transferred. |

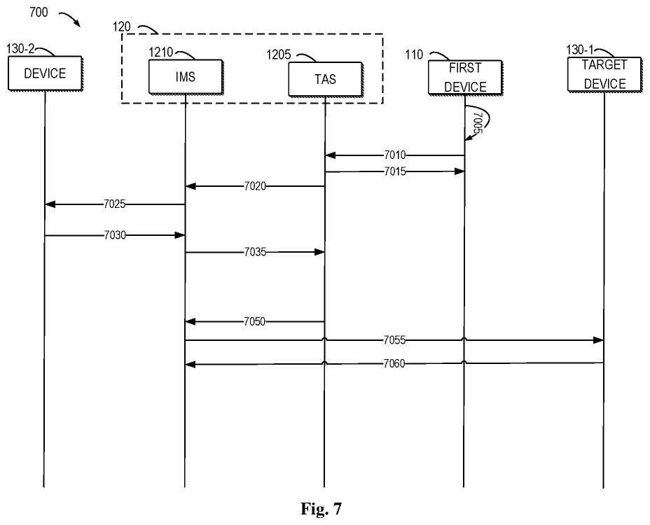

With the reference to FIG. 7, FIG. 7 illustrates a signaling chart of interactions 700 for initiating a new communication session among devices according to embodiments of the present disclosure. The interactions 700 can be implemented among any suitable devices. For the purpose of illustrations, the interactions 700 are described with the reference to the first device 110, the second device 120, the third device 130-1 and the device 130-2. It should be noted that the third device 130-1 is only an example not a limitation.

The first device 110 may determine 7005 to create the communication session between the device 130-2 and the target device 130-1. The first device 110 may use third party call API to make a call with specific device. The participantDevice element is added to specify the device(s) of participant. Any participant could include the optional participantDevice element to specify the target device(s). To support intercommunication among devices of the same user identity, the participant of POST request may include same participantAddress (same PUID), but with different target devices in participantDevice. Then the first device 110 may create a new communication session between devices of same PUID.

Referring back to FIG. 7, the first device 110 transmits 7010 the request to the TAS 1205 to create the communication session. The request may indicate the identity information of the third deice 130-1. The TAS 1205 may transmit 7015 an acknowledgement to the request to the first device 110. The TAS 1205 may transmit 7020 the request to the IMS 1210. The IMS 1210 may transmit 7025 the request to the device 130-2 as the calling participant. The device 130-2 may transmit 7030 the acknowledgement to the IMS 1210. The IMS 1210 may transmit 7035 the acknowledgement to the TAS 1205. The TAS 1205 may transmit 7050 another request to the IMS 1210. The IMS 1210 may transmit 7055 the other request to the third device 130-1 as the called participant device. The third device 1301-may transmit 7060 the acknowledgment to the IMS 1210.

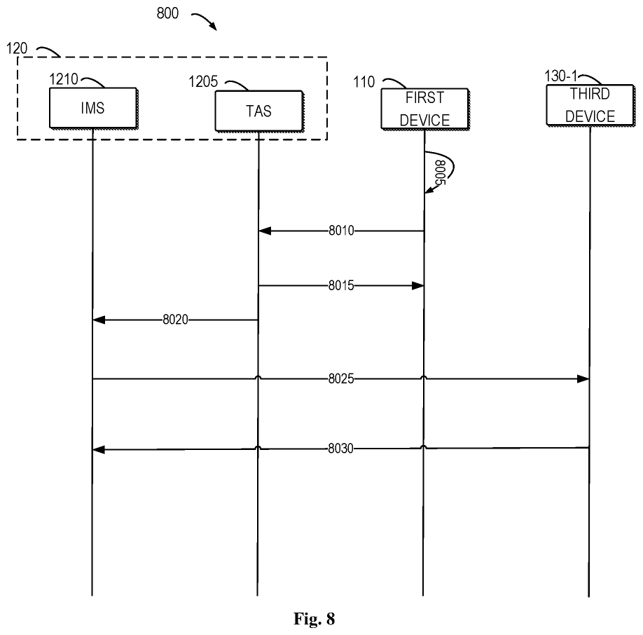

In some embodiments, one or more devices may be newly added into the communication session. FIG. 8 illustrates the interactions 800 for adding one or more devices into the communication session according to embodiments of the present disclosure. In some embodiments, the first device 110 may determine 8005 the third device 130-1 to be added into the communication session. The first device 110 may transmit 8010 to the TAS 1205 to add the third device 1301-1. For example, the CallParticipantlnformation in request can set the participantAddress to same PUID and the participantDevice to device want to bridge. Then the additional device can be added into the active communication session. The TAS 1205 transmits 8015 an ACK to the first device 110.

The TAS 1205 may transmit 8020 the request to add the third device 130-1 to the IMS 1210. The IMS 1210 may transmit 8025 the request to the third device 130-1 to add into the communication session. The third device 130-1 may transmit 8030 the acknowledgment to the IMS 1210.

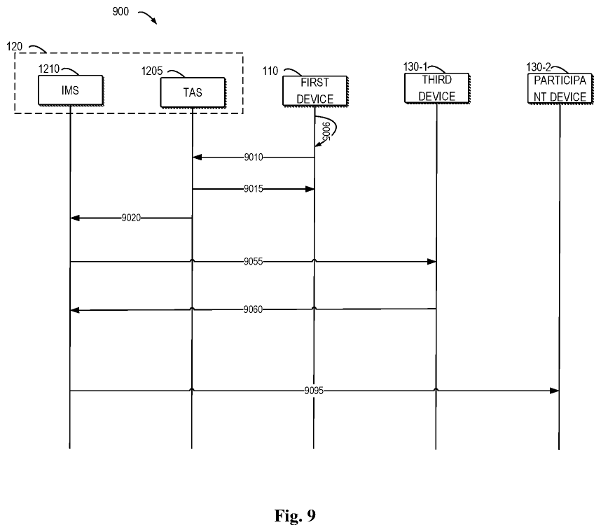

In some embodiments, the devices in the communication session may be transferred. In some embodiments, the transferred devices may have the same user identity. Alternatively or in addition, the transferred devices may have different user identities. FIG. 9 illustrates the interactions 900 for transferring devices in the communication session according to embodiments of the present disclosure. For MuD service, in addition to basic call connection, it could allow device transfer.

(1) Pull where an idle device “pulls” an active or held answered call from another device. The network connects the pulling device to the far party currently involved in the call that has been moved. To perform it, the first device 110 may use the POST method to submit the resourceURL identifying the target session to the resource below: http://{serverRoot}/thirdpartycall/{apiVersion}/call Sessions/{call SessionId}/participants/{participantId}/transfer/devices/{deviceId}/transfer. The destinationDevice of TransferParameters set to device want to pull the communication session.

(2) Push where a device involved in an active call “pushes” the active call to specific device. The first device 110 may connect the far party to the answer device and terminates the call with the pushing device. To perform it, the first device 110 may use the POST method to submit the resourceURL identifying the target session to the resource below: http://{serverRoot}/thirdpartycall/{apiVersion}/call Sessions/{call Sessionld}/participants/{participantId}/transfer/devices/{deviceId}/transfer. The destinationDevice of TransferParameters set to device want to push the communication session to.

(3) Broadcast Push where a device involved in an active call “Broadcast Push” the active call to all other MuD devices. The first device 130 connects the first answered device with far party and terminates the request to other devices. To perform it, use the POST method to submit the resourceURL identifying the target session to the resource below: http://{serverRoot}/thirdpartycall/{apiVersion}/call Sessions/{call Sessionld}/participants/{participantId}/transfer/devices/{deviceId}/transfer. The destinationDevice of TransferParameters set to ALL devices of participant. The first answered device will connect with far party and all other devices are dropped.

The first device 110 may determine 9010 to transfer the participant device 130-2 to the third device 130-1. The first device 110 may transmit 9010 the request to the TAS 1205 indicating the identity information of the third device 1301- and the participant device 130-2. The TAS 1205 may transmit 9015 the acknowledgment to the first device 110.

The TAS 1205 may transmit 9020 the request to the IMS 1210. The IMS 1210 may transmit 9055 the request to the third device 130-1 to participate the communication session. The third device 130-1 may transmit 9060 the acknowledgement to the IMS 1210. The IMS 1210 may transmit 9095 a further request to the participant device 130-2 to leave the communication session.

In some embodiments, the audio call API is to play media to call participant. To support device, the optional participantDevice element may be added to specify devices(s). Table 10 below sows an example of the media message.

TABLE 10

| Name | Type | Optional | Description |
|---|---|---|---|
| participantDevice | xsd: string | Yes | The set of |
| | [0 . . . unbounded] | | device |
| | | | addresses |
| | | | contained |
| | | | within the |
| | | | callSession to |
| | | | which the |
| | | | message is to |
| | | | be played. |

In some embodiments, an apparatus for performing the method 200 (for example, the first device 110) may comprise respective means for performing the corresponding steps in the method 200. These means may be implemented in any suitable manners. For example, it can be implemented by circuitry or software modules.

In some embodiments, the apparatus comprises means for receiving, at a first device, accessibility information associated with a user identity from a second device, the accessibility information indicating a plurality of devices using the user identity and capabilities of the plurality of devices; means for in an accordance with a detection of a change in a communication session associated with the plurality of devices, selecting at least one target device from the plurality of devices based on the capabilities of the plurality of devices and a requirement of the communication session; and means for transmitting identity information of the at least one target device to the second device.

In some embodiments, the means for receiving the accessibility information comprises: means for sending a request indicating the user identity to the second device; and means for receiving the accessibility information associated with the user identity from the second device.

In some embodiments, the apparatus further comprise means for in accordance with a determination that an update occurs in the accessibility information, receiving updated accessibility information from the second device.

In some embodiments, the means for selecting the at least one target device from the plurality of devices comprises: means for determining an initiation of the communication session; and means for selecting, from the plurality of devices, the at least one target device of which capability satisfies the requirement of the communication session.

In some embodiments, the means for selecting the at least one target device from the plurality of devices comprises: means for in accordance with a determination that at least one device is to be added into the communication session, selecting the at least one target device such that capability of the selected target device satisfies the requirement of the communication session.

In some embodiments, the means for selecting the at least one target device from the plurality of devices comprises: means for determining a participant device in the communication session to be replaced; and means for selecting the at least one target device to replace the participant device based on the requirement and the capabilities.

In some embodiments, the first device comprises a server, the second device comprises a core network device and the target device comprises a terminal device.

In some embodiments, an apparatus for performing the method 300 (for example, the second device 120) may comprise respective means for performing the corresponding steps in the 300. These means may be implemented in any suitable manners. For example, it can be implemented by circuitry or software modules.

In some embodiments, the apparatus comprises means for transmitting, at a second device and to a first device, accessibility information associated with a user identity from a second device, the accessibility information indicating a plurality of devices using the user identity and capabilities of the plurality of devices; means for in an accordance with a determination of a change in a communication session associated with the plurality of devices, receiving identity information of at least one target device from the first device, the at least one target device being determined based on the capabilities of the plurality of devices and a requirement of the communication session; and means for transmitting a request associated with the change to the at least one target device.

In some embodiments, the means for transmitting the accessibility information comprises: means for receiving a request indicating the user identity from the first device; and means for transmitting the accessibility information associated with the user identity to the first device.

In some embodiments, the apparatus comprises means for receiving a register request from a third device using the user identity, the register request indicating identity information of the third device and a capability of the third device; means for updating the accessibility information to include the identity information of the third device and the capability of the third device; and means for transmitting the updated accessibility information to the first device.

In some embodiments, the means for transmitting the request associated with the change comprises: means for in accordance with a determination of an initiation of the communication session, transmitting the request to the at least one target device to participate the communication session.

In some embodiments, the means for transmitting the request associated with the change comprises: means for in accordance with a determination of adding at least one device in the communication session, transmitting the request to the at least one target device to participate the communication session.

In some embodiments, the means for transmitting the request associated with the change comprises: means for in accordance with a determination of replacing a participant device in the communication session, transmitting the request to at least one target device to participate the communication session; and means for transmitting a further request to the participant device to leave the communication session.

In some embodiments, the first device comprises a server, the second device comprises a core network device and the target device comprises a terminal device.

In some embodiments, an apparatus for performing the method 400 (for example, the third device 130) may comprise respective means for performing the corresponding steps in the method 400. These means may be implemented in any suitable manners. For example, it can be implemented by circuitry or software modules.

In some embodiments, the apparatus comprises means for transmitting, at a third device and to a second device, a register request indicating identity information of the third device and a capability of the third device, the third device using a user identity, accessibility information associated with the user identity comprising the identity information of the third device and the capability of the third device; means for in an accordance with a determination of a change in a communication session associated with the plurality of devices, receiving a request associated with the change from the second device; means for generating a response to the request; and means for transmitting the response to the second device.

In some embodiments, the means for generating the response to the request comprises: means for in accordance with a determination the request indicates to participate the communication session, generating an acknowledgment to the request.

In some embodiments, the means for transmitting the request associated with the change comprises: means for in accordance with a determination the request indicates to leave the communication session, generating an acknowledgment to the request.

In some embodiments, the first device comprises a server, the second device comprises a core network device and the third device comprises a terminal device.

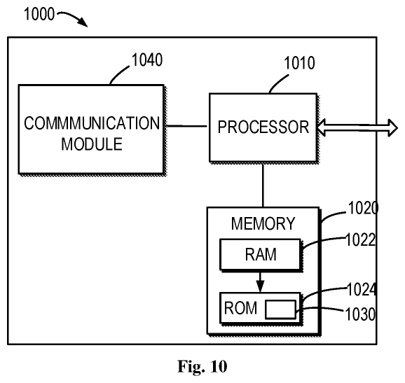

FIG. 10 is a simplified block diagram of a device 1000 that is suitable for implementing embodiments of the present disclosure. The device 1000 may be provided to implement the communication device, for example the first device 110, the second device 120, and the third devices 130 shown in FIG. 1. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has at least one antenna to facilitate communication. The communication interface may represent any interface that is necessary for communication with other network elements.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1024. The processor 1010 may perform any suitable actions and processing by loading the program 1030 into the RAM 1022.

Embodiments of the present disclosure may be implemented by means of the program 1020 so that the device 1000 may perform any process of the disclosure as discussed with reference to FIGS. 2 to 9. Embodiments of the present disclosure may also be implemented by hardware or by a combination of software and hardware.

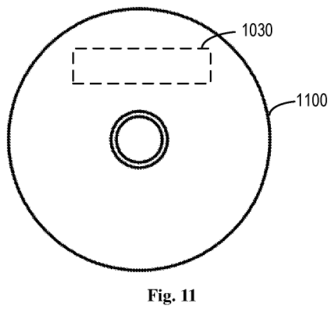

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. The computer readable medium may include any types of tangible non-volatile storage, such as ROM, EPROM, a flash memory, a hard disk, CD, DVD, and the like. FIG. 11 shows an example of the computer readable medium 1100 in form of CD or DVD. The computer readable medium has the program 1030 stored thereon.

It should be appreciated that future networks may utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications, this may mean node operations to be carried out, at least partly, in a central/centralized unit, CU, (e.g. server, host or node) operationally coupled to distributed unit, DU, (e.g. a radio head/node). It is also possible that node operations will be distributed among a plurality of servers, nodes or hosts. It should also be understood that the distribution of labor between core network operations and base station operations may vary depending on implementation.

In an embodiment, the server may generate a virtual network through which the server communicates with the distributed unit. In general, virtual networking may involve a process of combining hardware and software network resources and network functionality into a single, software-based administrative entity, a virtual network. Such virtual network may provide flexible distribution of operations between the server and the radio head/node. In practice, any digital signal processing task may be performed in either the CU or the DU and the boundary where the responsibility is shifted between the CU and the DU may be selected according to implementation.

Therefore, in an embodiment, a CU-DU architecture is implemented. In such case the device 1000 may be comprised in a central unit (e.g. a control unit, an edge cloud server, a server) operatively coupled (e.g. via a wireless or wired network) to a distributed unit (e.g. a remote radio head/node). That is, the central unit (e.g. an edge cloud server) and the distributed unit may be stand-alone apparatuses communicating with each other via a radio path or via a wired connection. Alternatively, they may be in a same entity communicating via a wired connection, etc. The edge cloud or edge cloud server may serve a plurality of distributed units or a radio access networks. In an embodiment, at least some of the described processes may be performed by the central unit. In another embodiment, the device 900 may be instead comprised in the distributed unit, and at least some of the described processes may be performed by the distributed unit.

In an embodiment, the execution of at least some of the functionalities of the device 900 may be shared between two physically separate devices (DU and CU) forming one operational entity. Therefore, the apparatus may be seen to depict the operational entity comprising one or more physically separate devices for executing at least some of the described processes. In an embodiment, such CU-DU architecture may provide flexible distribution of operations between the CU and the DU. In practice, any digital signal processing task may be performed in either the CU or the DU and the boundary where the responsibility is shifted between the CU and the DU may be selected according to implementation. In an embodiment, the device 1000 controls the execution of the processes, regardless of the location of the apparatus and regardless of where the processes/functions are carried out.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 200-400 as described above with reference to FIGS. 5-8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-27. (canceled)

28. A method comprising:
transmitting, at a second device and to a first device, accessibility information associated with a user identity, the accessibility information indicating a plurality of devices using the user identity and capabilities of the plurality of devices;
in an accordance with a determination of a change in a communication session associated with the plurality of devices, receiving identity information of at least one target device from the first device, the at least one target device being determined based on the capabilities of the plurality of devices and a requirement of the communication session; and
transmitting a request associated with the change to the at least one target device.

29. The method of claim 28, wherein transmitting the accessibility information comprises:
receiving a request indicating the user identity from the first device; and
transmitting the accessibility information associated with the user identity to the first device.

30. The method of claim 28, further comprising:
receiving a register request from a third device using the user identity, the register request indicating identity information of the third device and a capability of the third device;
updating the accessibility information to include the identity information of the third device and the capability of the third device; and
transmitting the updated accessibility information to the first device.

31. The method of claim 28, wherein transmitting the request associated with the change comprises:
in accordance with a determination of an initiation of the communication session, transmitting the request to the at least one target device to participate the communication session.

32. The method of claim 28, wherein transmitting the request associated with the change comprises:
in accordance with a determination of adding at least one device in the communication session, transmitting the request to the at least one target device to participate the communication session.

33. The method of claim 28, wherein transmitting the request associated with the change comprises:
in accordance with a determination of replacing a participant device in the communication session, transmitting the request to at least one target device to participate the communication session; and
transmitting a further request to the participant device to leave the communication session.

34. The method of claim 28, wherein the first device comprises an application server, the second device comprises a core network device and the target device comprises a terminal device.

35. A second device comprising:
at least one processor; and
at least one memory including computer program codes; the at least one memory and the computer program codes are configured to, with the at least one processor, cause the second device to perform:
transmitting, to a first device, accessibility information associated with a user identity, the accessibility information indicating a plurality of devices using the user identity and capabilities of the plurality of devices;
in an accordance with a determination of a change in a communication session associated with the plurality of devices, receiving identity information of at least one target device from the first device, the at least one target device being determined based on the capabilities of the plurality of devices and a requirement of the communication session; and
transmitting a request associated with the change to the at least one target device.

36. The second device of claim 35, wherein transmitting the accessibility information comprises:
receiving a request indicating the user identity from the first device; and
transmitting the accessibility information associated with the user identity to the first device.

37. The second device of claim 35, further comprising:
receiving a register request from a third device using the user identity, the register request indicating identity information of the third device and a capability of the third device;
updating the accessibility information to include the identity information of the third device and the capability of the third device; and
transmitting the updated accessibility information to the first device.

38. The second device of claim 35, wherein transmitting the request associated with the change comprises:
in accordance with a determination of an initiation of the communication session, transmitting the request to the at least one target device to participate the communication session.

39. The second device of claim 35, wherein transmitting the request associated with the change comprises:
in accordance with a determination of adding at least one device in the communication session, transmitting the request to the at least one target device to participate the communication session.

40. The second device of claim 35, wherein transmitting the request associated with the change comprises:
in accordance with a determination of replacing a participant device in the communication session, transmitting the request to at least one target device to participate the communication session; and
transmitting a further request to the participant device to leave the communication session.

41. The second device of claim 35, wherein the first device comprises an application server, the second device comprises a core network device and the target device comprises a terminal device.

42. A non-transitory computer readable storage medium comprising program instructions stored thereon, the instructions, when executed by second device, causing the second device to perform:
transmitting, to a first device, accessibility information associated with a user identity, the accessibility information indicating a plurality of devices using the user identity and capabilities of the plurality of devices;
in an accordance with a determination of a change in a communication session associated with the plurality of devices, receiving identity information of at least one target device from the first device, the at least one target device being determined based on the capabilities of the plurality of devices and a requirement of the communication session; and
transmitting a request associated with the change to the at least one target device.
